(19) United States
(12) Patent Application Publication
(10) Pub. No.: US 2006/0107814 A1
(43) Pub. Date: May 25, 2006

(54) Clamping Device

(76) Inventor: Colin Thompson, Stockton on Tees (GB)

Correspondence Address: PERRY HOFFMAN & ASSOCIATES P.C., PO BOX 1649, DEERFIELD, IL, 60015, US

(21) Appl. No.: 10/905,772

(22) Filed: Jan. 20, 2005

(30) Foreign Application Priority Data
Nov. 10, 2004 (GB) 0424745.8

(51) Int. Cl. B26D 7/02

(52) U.S. Cl. 83/452

(57) ABSTRACT

A clamping device is provided for clamping one or more workpieces in a pre-determined position in precision cutting apparatus. The clamping device includes a first portion having attachment means provided thereon for allowing attachment of the same directly to a work surface of the apparatus in use, and a second portion which is capable of being engaged with the first portion. The second portion forms at least part of or is associated with clamping means for clamping the one or more workpieces. The vertical and/or horizontal orientation of the clamping device is entirely dependent on the vertical and/or horizontal orientation of the work surface of the precision cutting apparatus to which the clamping device is attached in use.

This invention relates to a clamping device, and particularly but not necessarily exclusively to a clamping device for use in high precision wire erosion machinery.

The provision of clamping devices is essential in high precision wire erosion cutting machinery to ensure one or more articles being machined are located precisely in a pre-determined position. This ensures the accuracy of the cutting of said articles to within a few μm. The precision cutting machinery typically includes a flat and planar precision bed or worktable on which cutting of the articles takes place. A conventional clamping device includes a mounting head for mounting a spaced distance above the table and a holder or vice which is engaged with the mounting head. A levelling adaptor is located between the table and the mounting head to allow attachment and positioning of the mounting head above the table with accuracy in three axes with respect to the worktable.

A problem with conventional clamping devices is that the levelling adaptor is generally a complex arrangement of components which increases the complexity of the clamping device and makes the same prohibitively expensive to many potential customers. The vices allow horizontal clamping of workpieces only and since movement of a clamping member with respect to a further clamping member of the vice is restricted to a pre-determined length of the body portion or longitudinally of the vice, different sized vices need to be supplied for use with different sized workpieces. This also increases the cost associated with conventional clamping devices.

It is therefore an aim of the present invention to provide a clamping device which is simpler in form and less expensive to produce.

It is a further aim of the present invention to provide precision cutting apparatus including a clamping device which is simpler in form and less expensive to produce.

According to a first aspect of the present invention there is provided a clamping device for clamping one or more workpieces, said clamping device including a first portion having attachment means provided thereon for allowing attachment of the same directly to a work surface in use, and at least a second portion which is capable of being engaged with the first portion, said at least second portion forming at least part of or being associated with clamping means for clamping said one or more workpieces, and wherein the vertical and/or horizontal orientation of said clamping device is entirely dependent on the vertical and/or horizontal orientation of the work surface to which the clamping device is attached in use.

The work surface is preferably a work table of precision cutting apparatus.

Since the vertical and horizontal orientation of the worktable, surface or frame of the precision cutting apparatus is already precisely set by the apparatus manufacturers, the clamping device of the present invention does not require additional levelling adaptors to be supplied as in prior art devices. This makes the clamping device simpler to manufacture and less expensive to produce. In addition, maintaining the height of the work table typically equates to the most efficient setting of the apparatus and thus allows the fastest cutting speeds to be achieved.

Preferably the engagement means for engaging the first portion with said at least second portion includes at least one channel passing between said first and said at least second portion in which connection means are inserted in use, said channel being provided at an acute angle to the horizontal.

Preferably the channel is provided at an angle which slopes towards an upper surface of a work surface to which the portions are attached in use.

The entrances of said channels on the engaging surfaces of said first and second portions are substantially aligned on engagement. The channels slope in a direction from a top surface of said second portion to a base surface of said first portion to form a substantially continuous channel when the first and second portions are brought into engagement together. The slope of this channel enables a tool used to manipulate the connection means, such as an alien key and/or the like, to easily access the entrance aperture of said second portion without being restricted by the work table. In addition, on securing of the connection means in the channels of said second and first portions, the second portion is caused to move in a downwardly direction towards the first portion, thereby allowing repeatability of the connection position and thus ensuring repeatability of the accuracy of the cutting process.

Preferably the first portion of said clamping device is clamped directly to a worktable, surface and/or frame, such as a surface of a work table of high precision cutting apparatus. In an alternative embodiment, the first portion is clamped to the work table via at least a third or further portion.

Preferably the attachment means of said first portion includes one or more apertures or channels for the location of screws or similar connection means therethrough.

In one embodiment the apertures on the first portion are substantially aligned with pre-defined apertures provided on a work table of high precision cutting apparatus for attachment thereto, thereby removing the requirement for a user to drill additional apertures in the work table. Thus, the spacing of the apertures on said first portion typically substantially corresponds to the spacing of apertures on the work table.

Preferably the engagement means for engaging the first portion to said second portion further includes at least one protrusion portion provided on one of said first or second portions which engages in at least one complementary shaped recess portion in the other of said first or second portions.

Preferably the at least one channel on each of said first and second portions is provided in surfaces of said recess and protrusion portions.

Preferably the connection means includes a screw or bolt which is inserted into said channel for engagement of said first and second portions together. Tightening of said screw or bolt in said angled channel, moves the second portion towards the first portion and thus towards the surface on which the first and/or second portions are to be attached in use.

Preferably the first portion can be provided in either a substantially horizontal orientation or a substantially vertical orientation in use.

Thus, the first portion can be orientated in a substantially parallel orientation with respect to a worksurface and/or can be orientated in a substantially perpendicular orientation with respect to a worksurface. This is in contrast to prior art clamping devices which can only be used in a substantially horizontal orientation or substantially parallel with respect to a work table.

In one embodiment the first portion is in direction engagement with a suitable surface in use, such as an upper surface of a work table of precision cutting apparatus.

In an alternative embodiment at least a third portion is provided between the suitable surface and said first portion. The third portion engages said first portion in a similar manner to the engagement between the first and second portions.

With the first portion in a substantially vertical orientation, the second portion typically engages with a side surface thereof. Thus, the first portion is typically in the form of an elongate arm which is located substantially perpendicularly to an upper surface of a work table or other suitable surface. A protrusion portion or recess portion, typically elongated in form, is provided longitudinally of said arm and a complementary recess portion or protrusion portion is provided on said at least second portion and/or third portion for engagement therewith.

Preferably a plurality of apertures or channels are provided on said protrusion or recess portion at spaced apart intervals to allow connection means in the form of a screw, bolt or similar to be located through the second and first portions. This allows a plurality of at least second portions or third portions to be attached thereto in a stacked arrangement, thereby allowing firm clamping of a single workpiece and/or allowing firm clamping of a plurality of workpieces, each workpiece being clamped by a separate second portion.

The apertures or channels are typically arranged longitudinally of said first portion.

The advantage of the vertically arranged first portion is that elongate workpieces can be clamped in said clamping device. For example, a second portion can be located adjacent the top of the workpiece and a further second portion can be located adjacent the bottom of the workpiece without the risk of the apparatus or workpiece tipping over or moving during machining. The workpiece can be any suitable height, such as between 100 mm-400 mm.

According to a second aspect of the present invention there is provided a clamping device for clamping one or more workpieces, said clamping device including a first portion having attachment means provided thereon for allowing attachment of the same to a worksurface, at least a second portion which is capable of being engaged with the first portion, said second portion forming at least part of or being associated with clamping means for clamping said one or more workpieces and wherein the engagement means for engaging the first portion with said at least second portion includes at least one channel passing between said first and said at least second portion in which connection means are inserted in use, said channel being provided at an acute angle to the horizontal.

According to a third aspect of the present invention there is provided a clamping device for clamping one or more workpieces, said clamping device including a first portion having attachment means provided thereon for allowing attachment of the same to a worksurface, at least a second portion which is capable of being engaged with the first portion, said second portion forming at least part of or being associated with clamping means for clamping said one or more workpieces and wherein the first portion can be provided in either a substantially horizontal orientation or a substantially vertical orientation in use.

According to a further aspect of the present invention there is provided precision cutting apparatus including a clamping device.

Reference to precision cutting apparatus includes wire erosion machining and/or the like.

Embodiments of the present invention will now be described with reference to the accompanying figures, wherein:

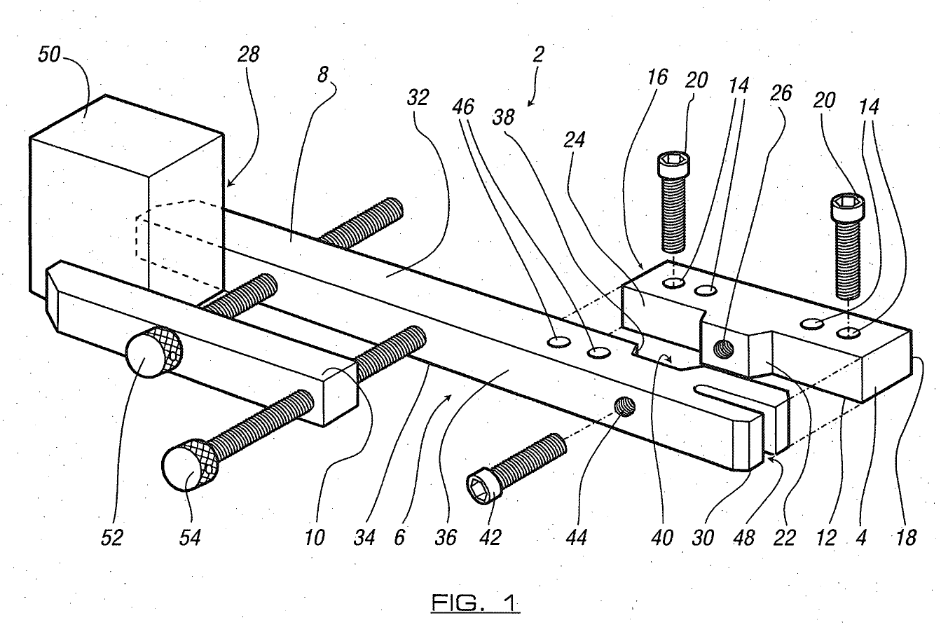

FIG. 1 is a perspective view of a clamping device according to an embodiment of the present invention;

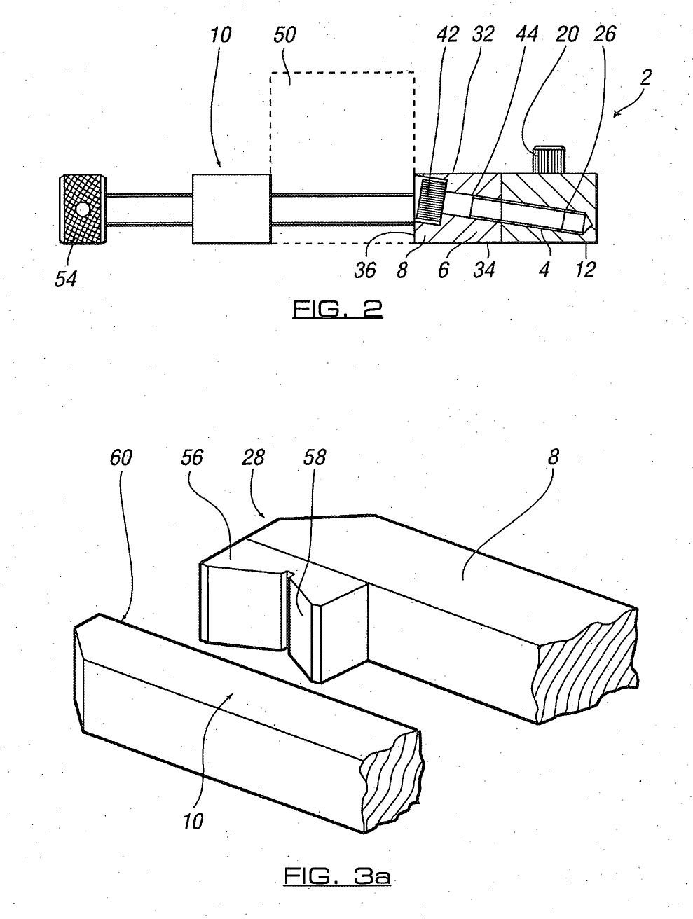

FIG. 2 is a cross sectional view of an end of the clamping device in FIG. 1;

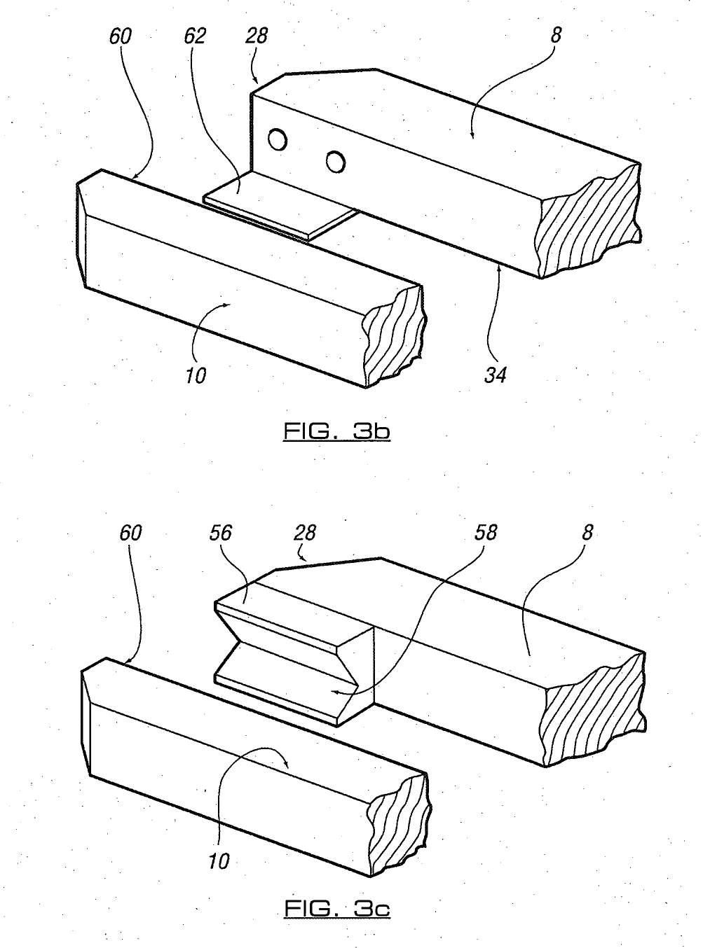

FIGS. 3a-3d illustrate examples of different types of clamping members which can be used with the present invention;

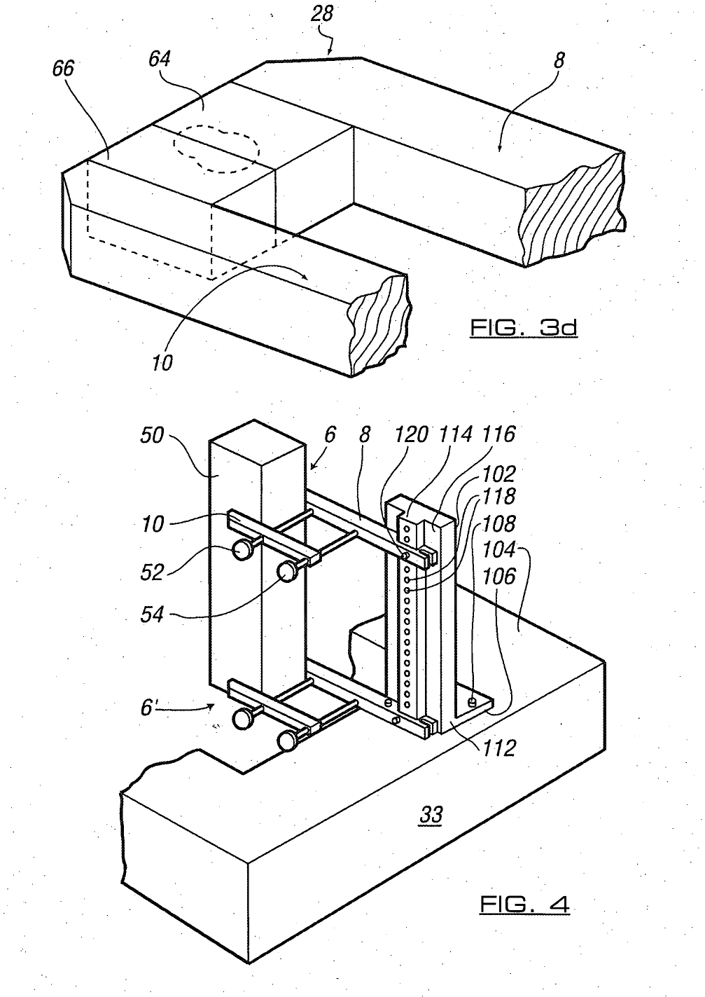

FIG. 4 is a perspective view of a clamping device according to an embodiment of the present invention used in a vertical orientation;

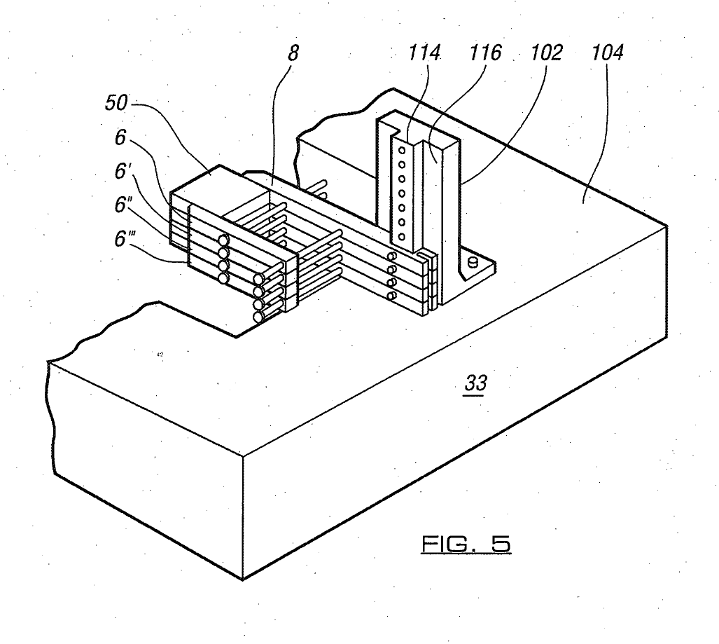

FIG. 5 is a perspective view of a plurality of clamping devices used in combination with each other in a vertical orientation;

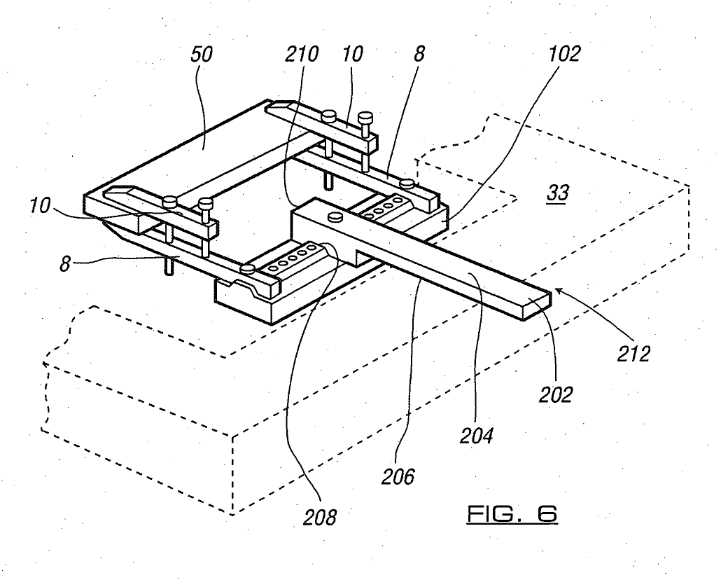

FIG. 6 is a further embodiment of a clamping device of the present invention; and

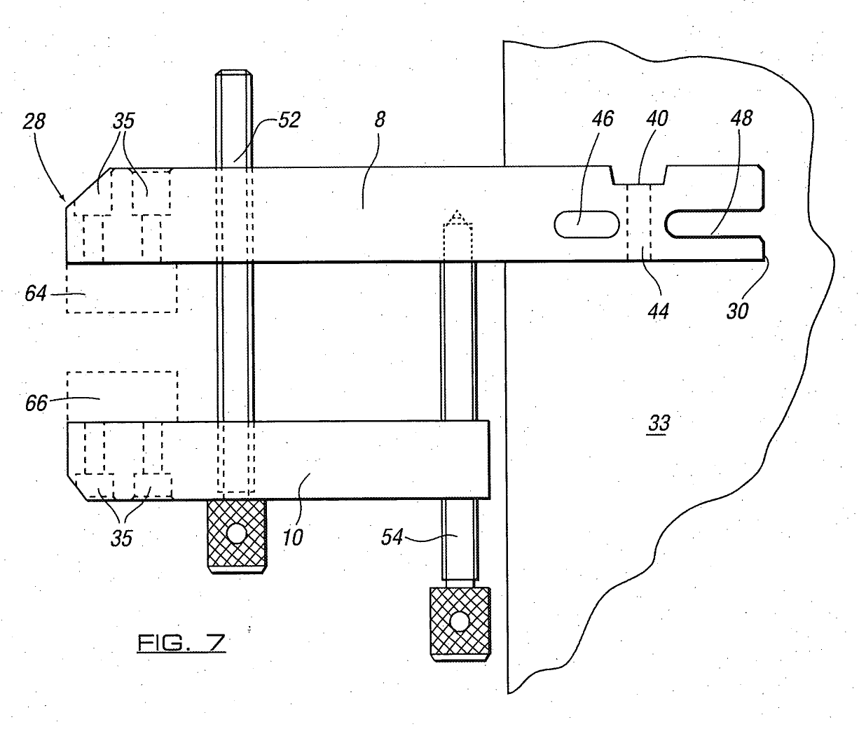

FIG. 7 is a plan view of a clamping device according to one embodiment of the present invention in which the second portion is attached directly to a worktable.

Referring firstly to FIG. 1, there is illustrated a clamping device 2 for use with high precision wire erosion apparatus (HPWEA) (not shown). The HPWEA includes a worktable which in one example is typically in the form of a substantially horizontal square frame. The frame includes a plurality of apertures located at spaced apart intervals thereon.

The device 2 includes a first portion 4 for attachment directly to the worktable and a second portion 6 for engagement with the first portion. The second portion 6 includes a first clamping member 8 and a second clamping member 10.

In order to simplify the clamping device of the present invention compared to prior art devices, first portion 4 is attached directly to the worktable. Since the worktable is preset in a substantially flat and planar manner, attachment of first portion 4 directly thereto will ensure levelling of the clamping device 2 within acceptable tolerances for most applications.

A base surface 12 of first portion 4 is located parallel with and adjacent to a top surface of the worktable frame. Apertures 14 provided at either end 16, 18 of portion 4 allow the location of engaging bolts 20 therethrough. The spacing of apertures 14 is substantially complementary to the spacing of apertures provided in the work table frame, such that the engaging bolts can locate in both apertures 14 and the work table frame apertures. The engaging bolts are located in position in the direction of instalment of the first portion on the worktable frame.

Engagement means in the form of a protrusion portion 22 is provided on a side wall 24 of first portion 4. In this example, protrusion portion 22 is located substantially centrally of first portion 4 and has a narrowing taper in a direction away from first portion 4. A channel 26 is provided through protrusion portion 22, the opening of channel 26 being located on the surface which engages with the second portion 6 in use.

First clamping member 8 of second portion 6 is in the form of an elongate arm. Further elongate arms can be provided if required. The arm has a first end 28, a second end 30, a top surface 32, a base surface 34 and side walls 36, 38.

A recess portion 40 is defined in side wall 38 adjacent end 30 which is substantially complementary in shape to protrusion portion 22. Thus, in this example, recess portion 40 has a diverging taper in the direction towards first portion 4 to increase the ease of engagement of protrusion 22 into recess 40. In use, the surfaces of side walls 24, 38 are brought into engagement, such that the protrusion portion 22 engages in recess portion 40. This engagement is further secured via fixing means in the form of a bolt 42 which is located through a channel 44 passing from side wall 36 to side wall 38 in the recess portion. A bolt 42 can be located through said channel 44 and into channel 26, the channels 44 and 26 being arranged substantially in alignment on alignment of said protrusion and recess portions 22, 40.

Channels 44 and 26 are provided at an acute angle to the horizontal, as shown in FIG. 2, for two reasons. Firstly, provision of the opening of channel 44 on side wall 36 towards top surface 32 increases the ease with which a user can locate a fixing tool, such as a screw driver or alien key therewith, without the worktable causing obstruction. Secondly, when bolt 42 is being tightened it moves clamping member 8 towards first portion 4 and the apparatus worktable, thereby allowing repeatability in the positioning of the first portion with the second portion 6 and thus allowing repeatability in the accuracy of the cutting process of a workpiece clamped in device 2.

Apertures 46 can be provided on top surface 32 of clamping member 8 which pass through to base surface 34. These apertures allow the first clamping member 8 to be located directly to a work table 33 if required, as shown in FIG. 7. A slot 48 can also be provided at end 30 of clamping member 8 to allow further fixing screws or attachment means to be located therethrough to secure the second portion 6 directly to the work table. The slot allows different sized attachment means to be used.

Once the first clamping member 8 is engaged with first portion 4, a workpiece 50 can be located between clamping members 8 and 10 adjacent end 28.

Clamping member 10 is a fraction of the length of clamping member 8 to allow access to be gained to engagement means/attachment means provided on member 8. Member 10 is provided substantially parallel to member 8 at an end opposite to the end at which the second portion 6 is joined to the worktable or first portion 4. Rotatable members in the form of clamping screws 52 and 54 are provided parallel to each and at spaced apart intervals between first clamping member 8 and second clamping member 10 to join the same together and to allow relative movement of the members. Movement of screw 52 allows relative movement of clamping member 10 with respect to clamping member 8 to allow a workpiece 50 to be located therebetween. Movement of screw 54 allows the clamping force between members 8 and 10 to be effected. This relative movement is in a direction substantially perpendicular to the longitudinal axis of the first and second clamping members. The length of screw 52 typically determines the size of workpiece 50 that can be located between the clamping members.

The opposing surfaces of clamping members 8 and 10 in FIG. 1 are substantially planar or flat in form. However, the opposing surface or surfaces of said clamping member could be in any suitable size or shape to allow accommodation of different sized or shaped workpieces, as shown in FIGS. 3a-3d, at or adjacent the free ends thereof. The different surfaces of said clamping members can be as a result of different integrally formed shaped ends or due to attachments which are located onto the end 28 of said clamping member or members. The attachments can be located via screws 35, as shown by dotted lines in FIG. 7, thereby allowing them to be detached if required.

In FIGS. 3a and 3c, clamping member 8 is provided with a portion 56 adjacent end 28. A V-shaped recess 58 is defined on the opposing surface to clamping surface 60 of clamping member 10. In FIG. 3a the narrowest point of the V-shaped recess is provided in a substantially vertical orientation and in FIG. 3b is provided in a substantially horizontal orientation.

In FIG. 3b, a plate portion 62 is provided adjacent base 34 of clamping member 8, which extends parallel to said base 34 towards surface 60 of clamping member 10.

In FIG. 3d, portions 64, 66 are provided on ends 28 of both clamping member 8 and clamping member 10 on opposing surfaces thereof. Portions 64, 66 can be any suitable shape or size to fit any sized or shaped workpiece thereto.

A further embodiment of the present invention is illustrated in FIG. 4 in which the first portion is in the form of a locating tower 102 which is arranged in a substantially vertical orientation, compared to the substantially horizontal orientation in FIG. 1.

Thus, a base 106 of locating tower 102 is located on a top surface 104 of a work table 33 and is secured thereto via screws 108 located through apertures provided in base 106. The main body portion 110 of tower 102 extends substantially perpendicularly to the upper surface of said work table and said base 104. More specifically, body portion 106 is provided at an end 112 of base 10. Engagement means in the form of a protruding strip 114 is provided on surface 116 of portion 110. Strip 114 is provided longitudinally of tower 102 and a plurality of apertures/channels 118 located at spaced apart intervals therealong.

First clamping member 8 of second portion 6 can be joined to tower 102 via recess portion 40 and secured via an engagement screw 120 as described in FIG. 1. A further second portion 6′ can be joined to tower 102 to allow clamping of an elongate workpiece at two spaced apart locations, as shown in FIG. 4. Alternatively, any number of second portions can be joined to first portion 102 as required to allow suitable clamping of a workpiece or plurality of stacked workpieces, as shown in FIG. 5. The second portions are stacked on top of each other or above each other as required. Tower 102 can be any suitable height and can have any suitable number of connection points thereon to allow second portions to be attached thereto.

The advantage of clamping each workpiece of a plurality of workpieces separately is that each workpiece is capable of being removed from the cutting apparatus for inspection and/or measurement purposes during a pause in machining and then precisely relocated in position in the clamping device. In addition, the ability to machine a plurality of components simultaneously increases the productivity of the machining process.

The tower 102 can be joined to work table via a third portion 202, as shown in FIG. 6. Third portion 202 has a top surface 204 and a lower surface 206. A recess portion 208 corresponding to recess portion 40 of second portion 6 is provided at end 210 thereof. The opposite end 212 is joined to a top surface of work table 33 via appropriate attachment means. This arrangement is particularly useful for cutting large die plates or for the individual mounting of several components using several second clamping portions arranged substantially horizontally.

Thus, it can be seen that the present invention can be used in both a substantially horizontal and/or vertical orientation as well as a singular and/or plural configuration, whereas prior art clamping devices of this nature, are restricted to only horizontal and mainly singular application.

What is claimed is:

1. A clamping device for clamping one or more workpieces, said clamping device including a first portion having attachment means provided thereon for allowing attachment of the same directly to a work surface in use, and at least a second portion which is capable of being engaged with the first portion, said at least second portion forming at least part of or being associated with clamping means for clamping said one or more workpieces, and wherein the vertical and/or horizontal orientation of said clamping device is entirely dependent on the vertical and/or horizontal orientation of the work surface to which the clamping device is attached in use.

2. A clamping device according to claim 1 wherein the engagement means for engaging the first portion with said at least second portion includes at least one channel passing between said first and at least second portion in which connection means are inserted in use.

3. A clamping device according to claim 2 wherein the channel is provided at an acute angle to the horizontal.

4. A clamping device according to claim 3 wherein the channel is provided at an angle which slopes towards an upper surface of the worksurface to which the clamping device is attached in use.

5. A clamping device according to claim 2 wherein the at least second portion is moved in a downwardly direction towards said at least first portion.

6. A clamping device according to claim 2 wherein the engagement means further includes at least one protrusion portion provided on one of said first or at least second portions which engages in at least one complementary shaped recess portion in the other of said first or second portions.

7. A clamping device according to claim 2 wherein the at least one channel is provided in a surface of said at least one recess and protrusion portions.

8. A clamping device according to claim 6 wherein the at least one channel is provided in a surface of said at least one recess and protrusion portions.

9. A clamping device according to claim 6 wherein the at least one protrusion as a narrowing taper towards its free end and the at least one recess has a diverging taper towards its open end.

10. A clamping device according to claim 2 wherein the connection means includes a screw or bolt.

11. A clamping device according to claim 1 wherein the attachment means of said first portion includes one or more apertures or channels for the location of one or more fixing screws or similar connection means therethrough.

12. A clamping device according to claim 11 wherein the one or more apertures or channels are substantially in alignment with one or more apertures or channels provided on a worktable of precision cutting apparatus to which it is to be clamped in use.

13. A clamping device according to claim 1 wherein the first portion can be provided in either a substantially horizontal orientation or a substantially vertical orientation.

14. A clamping device according to claim 1 wherein at least a third portion is provided for engagement between the first portion and the work surface in use.

15. A clamping device according to claim 1 wherein with the first portion to be provided substantially perpendicularly to the surface of the precision cutting apparatus to which it is to be attached in use, an elongate protrusion or recess portion is provided longitudinally thereof to allow engagement of at least a second portion thereto.

16. A clamping device according to claim 15 wherein a plurality of apertures or channels are provided at spaced apart intervals along the elongate protrusion or recess portion to allow connection means to be inserted therethrough.

17. A clamping device according to claim 15 wherein a plurality of second portions are attached to the first portion to form a stack.

18. A clamping device according to claim 1 wherein a base of the first portion is attached to an upper surface of the work surface and the at least second portion is attached to a side wall of the first portion in use.

19. A clamping device according to claim 1 wherein the second portion is in the form of at least one elongate arm.

20. A clamping device according to claim 1 wherein attachment means are provided on the at least second portion to allow the same to be attached to a suitable work surface or to a third or further portion in use.

21. A clamping device according to claim 1 wherein the clamping means includes two clamping members which are movable relative to each other to allow clamping of one or more workpieces located between said clamping members.

22. A clamping device according to claim 21 wherein one of the two clamping members is substantially shorter in length than the other clamping member.

23. A clamping device according to claim 21 wherein the clamping members are arranged substantially parallel to each other.

24. A clamping device according to claim 21 wherein the relative movement of the clamping members is in a direction substantially perpendicular to the longitudinal axis of the clamping members.

25. A clamping device according to claim 21 wherein one or more rotatable members are provided between the two clamping members and rotation of said rotatable members moves the clamping members relative to each other.

26. A clamping device according to claim 21 wherein one or both of the opposing surfaces of said clamping members is substantially planar or flat in form.

27. A clamping device according to claim 21 wherein one or both of the opposing surfaces of said clamping members is provided in a pre-determined shape at or adjacent a free end thereof.

28. A clamping device according to claim 27 wherein attachment members of said pre-determined shape are attached at or adjacent the free ends of one or both of said clamping members.

29. Precision cutting apparatus including a clamping device according to claim 1.

30. Precision cutting apparatus according to claim 29 wherein the precision cutting apparatus includes a substantially horizontally arranged worktable and said clamping device is attached to an upper surface thereof.
